(19) United States
(12) Patent Application Publication
(10) Pub. No.: US 2009/0015229 A1
(43) Pub. Date: Jan. 15, 2009

(54) Bi-directional DC power converter

(76) Inventor: Sridhar V. Kotikalapoodi, Santa Clara, CA (US)

Correspondence Address: BAY AREA INTELLECTUAL PROPERTY GROUP, LLC, PO BOX 210459, SAN FRANCISCO, CA, 94121-0459, US

(21) Appl. No.: 11/879,050

(22) Filed: Jul. 14, 2007

(51) Int. Cl. G05F 1/565

(52) U.S. Cl. 323/285

(57) ABSTRACT

A bidirectional power converter is presented. The power converter includes a circuit having a first and second power node and a first and a second internal node. Energy storage components are coupled between the power nodes and ground. A first switch is coupled between the first power node and the first internal node. A second switch is coupled between the first internal node and ground. A third switch is coupled between the second internal node and ground. A fourth switch is coupled between the second power node and second internal node. An inductive component is coupled between the first internal node and second internal node. A controller controls the switches in a manner such that power conversion occurs from the first to the second power node, from the second to the first power node, or power conversion is disabled and the power nodes are isolated from each other.

### FEDERALLY SPONSORED RESEARCH OR DEVELOPMENT

Not Applicable.

### REFERENCE TO SEQUENCE LISTING, A TABLE, OR A COMPUTER LISTING APPENDIX

Not Applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to power conversion. More particularly, the present invention relates to a bi-directional direct current (DC) power converter.

### BACKGROUND OF THE INVENTION

Typical electrical systems may contain several power sources. FIG. 1 is a block diagram of an exemplary prior art device for bi-directional power conversion comprising two, one directional power converters J1 and J2 and two power buses, power bus1 and power bus2. When a power source on power bus1 is present, this power source may be used to supply power to components on power bus2. However, the voltage of the power source on power bus1 may not be suitable to power the components on power bus2. In this case, a power converter J1 performs the required power conversion. Additionally, the voltage of the power source on power bus1 may be un-regulated, for example, without limitation, the voltage may sometimes be higher than the voltage required on power bus2 and other times may be equal to or less than the voltage required on power bus2. Thus power converter J1 is desired to provide buck-boost. Buck-boost is the ability to support both step-up and step-down operations. Additionally it may be still required for power converter J1 to deliver power for functions such as, but not limited to, battery charging to power bus2.

Similarly, when a power source is present on power bus2, this power source may be required to provide power to components connected on power bus1. Thus a power converter J2 performs the required power conversion and provides the power flow from power bus2 to components connected on power bus1. As can be seen in FIG. 1, two components are required to perform bi-directional current flow. Power converter J1 is a step-down or non-inverting buck-boost converter, and J2 is a step-up or non-inverting buck-boost converter.

FIG. 2 is a circuit diagram of an exemplary prior art device for bidirectional power conversion. This conventional device has several shortcomings. Firstly, the present device can provide step-up in one direction and step-down in the other direction. If the input voltage is unregulated and goes above, is equal to, or goes below the voltage required on the output, this configuration fails to regulate the output voltage, and the device cannot convert power if the voltage on node J1 and node J2 are about equal in magnitude. Secondly, if a voltage is present on a node J2 and no voltage is present on a node J1, the body diode of a transistor Q1 is forward biased and starts conducting. Thus the reverse leakage current flow through a body diode D1 of a transistor Q1 is always present. Thirdly, the power sources on node J1 and/or node J2 may be current limited. The implementation that senses only voltages and not input currents may not work properly if the load tries to draw higher current than that can be provided. Although the current device may sense the current flowing into a battery connected to node J2 through a current sense resistor connected in series with the battery, the input current through the power source on node J1 may be higher than the current through the battery sense resistor as many other components may be connected to node J2 that draw additional current. Thus, means of sensing and limiting the current through the input is required for this device.

In view of the foregoing, there is a need for an improved device for bi-directional DC power conversion that is contained in a single device, provides step-up and step-down conversion, generally prevents reverse leakage, and has means of current sense and current limit capability.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of an exemplary prior art device for bi-directional power conversion comprising two, one directional power converters J1 and J2 and two power buses, power bus1 and power bus2;

FIG. 2 is a circuit diagram of an exemplary prior art device for bi-directional power conversion;

FIG. 3 is a circuit diagram illustrating an exemplary bi-directional power converter that is able to step-up and step-down in both directions, in accordance with an embodiment of the present invention;

FIGS. 4a, 4b, 4c are circuit diagrams illustrating the operation of switching elements in a single period of power conversion from a power node N1 to a power node N2 in an exemplary bi-directional power converter in buck-boost mode, according an embodiment of the present invention. FIG. 4a illustrates phase 1, FIG. 4b illustrates phase 2, and FIG. 4c illustrates phase 3;

FIG. 5a and 5b are circuit diagrams illustrating the operation of switching elements in an exemplary bi-directional power converter in a single period of power conversion from a power node N1 to a power node N2 when only step-down operation is required from power node N1 to power node N2, in accordance with an embodiment of the present invention. FIG. 5a illustrates the current flow in phase 1, and FIG. 5b illustrates the current flow in phase 2;

FIG. 6a and 6b are circuit diagrams illustrating the operation of switching elements in an exemplary bi-directional power converter in a single period of power conversion from a power node N2 to a power node N1 when only step-up operation is required from power node N2 to power node N1, in accordance with an embodiment of the present invention. FIG. 6a illustrates the current flow in phase 1, and FIG. 6b illustrates the current flow in phase 2;

FIG. 7 is a circuit diagram of an exemplary bi-directional power converter where only step-down power conversion from a power node N1 to a power node N2 and step-up power conversion from power node N2 to power node N1 is required, in accordance with an embodiment of the present invention;

FIGS. 8a, 8b, 8c, and 8d illustrate various exemplary power train elements of a bi-directional power converter, in accordance with embodiments of the present invention. FIG. 8a illustrates a four-switch power train. FIG. 8b illustrates a three-switch power train. FIG. 8c, illustrates a two-switch power train with a current sensing element, and FIG. 8d illustrates a two-switch power train;

FIG. 9 illustrates various exemplary implementations of switch elements of an exemplary power converter, in accordance with embodiments of the present invention.

FIG. 10 illustrates exemplary switching elements, including a schematic model showing the parasitic conduction diode in a single and series connected PMOS/NMOS MOSFET transistors;

FIGS. 11a and 11b illustrate exemplary implementations for a current sensing function in a bi-directional power converter, in accordance with embodiments of the present invention. FIG. 11a illustrates a current sensing function employing a resistor, and FIG. 11b illustrates a current sensing function that measures the voltage across a switching transistor;

FIGS. 12a and 12b are block diagrams illustrating exemplary implementations of using a bi-directional converter in an electronic system for battery charging, in accordance with embodiments of the present invention. FIG. 12a illustrates a system with bi-directional converter providing the intermediate system voltage which used by the battery charger for charging the battery, and FIG. 12b illustrates a system with bi-directional power converter providing battery charge function in addition to providing bi-directional power conversion.

Unless otherwise indicated illustrations in the figures are not necessarily drawn to scale.

### SUMMARY OF THE INVENTION

To achieve the forgoing and other objects and in accordance with the purpose of the invention, a bi-directional DC power converter is presented.

In one embodiment, a bi-directional power converter is presented. The power converter includes a circuit having a first power node, a second power node, a first internal node and a second internal node. A first energy storage component is coupled between the first power node and ground. A second energy storage component is coupled between the second power node and ground. A first switch is coupled between the first power node and the first internal node, wherein the first switch allows current flow between the first power node and the first internal node when the first switch is in a closed position. A second switch is coupled between the first internal node and ground, wherein the second switch allows current flow between the first internal node and ground when the second switch is in a closed position. A third switch is coupled between the second internal node and ground, wherein the third switch allows current flow between the second internal node and ground when the third is in a closed position. A fourth switch is coupled between the second power node and second internal node, wherein the fourth switch allows current flow between the second power node and the second internal node when the fourth switch is in a closed position. An inductive component is coupled between the first internal node and second internal node. A controller has a first voltage-sensing input coupled to the first power node, a second voltage-sensing input coupled to the second power node and switch control outputs for controlling the first, second, third and fourth switches in a manner such that power conversion occurs from the first power node to the second power node, from the second power node to the first power node, or power conversion is disabled and the first and second power nodes are isolated from each other. In another embodiment, the controller further includes means for determining direction of an input to the converter. In another embodiment, the controller further includes a pulse generator for controlling the first, second, third and fourth switches, the pulse generator being controlled in part by a signal from the first or second voltage-sensing input. In still another embodiment, the power converter further includes current sensing means capable of producing a feedback signal for the controller where the pulse generator is controlled in part by the feedback signal. In yet another embodiment, one or more of the first, second, third and fourth switches include the current sensing means. In a further embodiment, the inductive component includes the current sensing means. In yet another embodiment, the feedback signal indicates a current of the input and the pulse generator is controlled to limit the current.

In another embodiment, a bi-directional power converter is presented. The power converter includes a circuit including a first power node, a second power node, a first internal node and a second internal node. A first energy storage component is coupled between the first power node and ground. A second energy storage component is coupled between the second power node and ground. A first switch is coupled between the first power node and the first internal node, wherein the first switch allows current flow between the first power node and the first internal node when the first switch is in a closed position. A second switch is coupled between the first internal node and ground, wherein the second switch allows current flow between the first internal node and ground when the second switch is in a closed position. A third switch is coupled between the second power node and second internal node, wherein the third switch allows current flow between the second power node and the second internal node when the third switch is in a closed position. An inductive component is coupled between the first internal node and second internal node. A controller includes a first voltage-sensing input coupled to the first power node, a second voltage-sensing input coupled to the second power node and switch control outputs for controlling the first, second and third switches in a manner such that power conversion occurs from the first power node to the second power node, from the second power node to the first power node, or power conversion is disabled and the first and second power nodes are isolated from each other. In another embodiment, controller further includes means for determining direction of an input to the converter. In a further embodiment, the controller further includes a pulse generator for controlling the first, second and third switches, the pulse generator being controlled in part by a signal from the first or second voltage-sensing input. Another embodiment further includes current sensing means capable of producing a feedback signal for the controller where the pulse generator is controlled in part by the feedback signal. In still another embodiment, one or more of the first, second and third switches include the current sensing means. In yet another embodiment, the inductive component includes the current sensing means. In a further embodiment, the feedback signal indicates a current of the input and the pulse generator is controlled to limit the current.

In another embodiment, a bi-directional power converter is presented. The power converter includes a circuit includes a first power node, a second power node and an internal. A first energy storage component is coupled between the first power node and ground. A second energy storage component is coupled between the second power node and ground. A first switch is coupled between the first power node and the internal node, wherein the first switch allows current flow between the first power node and the internal node when the first switch is in a closed position and leakage current is substantially prevented in an open position. A second switch is coupled between the internal node and ground, wherein the second switch allows current flow between the internal node and ground when the second switch is in a closed position and leakage current is substantially prevented in an open position. An inductive component is coupled between the first internal node and second power node. A controller includes a first voltage-sensing input coupled to the first power node, a second voltage-sensing input coupled to the second power node and switch control outputs for controlling the first and second switches in a manner such that power conversion occurs from the first power node to the second power node, from the second power node to the first power node, or power conversion is disabled and the first and second power nodes are isolated from each other. In another embodiment, the controller further includes means for determining direction of an input to the converter. In yet another embodiment, the controller further includes a pulse generator for controlling the first and second switches, the pulse generator being controlled in part by a signal from the first or second voltage-sensing input. Another embodiment further includes current sensing means capable of producing a feedback signal for the controller where the pulse generator is controlled in part by the feedback signal. I still another embodiment, the first or second switch includes the current sensing means. In a further embodiment, the inductive component includes the current sensing means. In still another embodiment, the feedback signal indicates a current of the input and the pulse generator is controlled to limit the current.

In another embodiment, a bi-directional power converter is presented. The power converter includes a circuit including a first power node, a second power node, a first internal node and a second internal node, first energy storage means for storing energy on the first power node, second energy storage means for storing energy on the second power node, first switch means for allowing current flow between the first power node and the first internal node, second switch means for allowing current flow between the first internal node and ground, third switch means for allowing current flow between the second internal node and ground, fourth switch means for allowing current flow between the second power node and the second internal node, inductive means for transferring current between the first internal node and second internal node and controller means for controlling the first, second, third and fourth switch means in a manner such that power conversion occurs from the first power node to the second power node, from the second power node to the first power node, or power conversion is disabled and the first and second power nodes are isolated from each other. Other embodiments further include voltage sense means for sensing voltage at the power nodes and current sense means for sensing current in the power nodes.

In another embodiment, a circuit for use in a bi-directional power converter is presented. The circuit includes a power train having a first power node, a second power node, a first internal node and a second internal node, first energy storage means for storing energy on the first power node, second energy storage means for storing energy on the second power node, first switch means for allowing current flow between the first power node and the first internal node, second switch means for allowing current flow between the first internal node and ground, third switch means for allowing current flow between the second internal node and ground, fourth switch means for allowing current flow between the second power node and the second internal node and inductive means for transferring current between the first internal node and second internal node where when the switches are controlled power conversion occurs between the power nodes. Other embodiments voltage sense means for sensing voltage at the power nodes and current sense means for sensing current in the power nodes.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

The present invention will now be described in detail with reference to embodiments thereof as illustrated in the accompanying drawings.

The preferred embodiment of the present invention is a method and apparatus to provide bi-directional power conversion. In the preferred embodiment, the power converter can convert power in a first direction, in a second direction or can be turned off. A single converter according to the preferred embodiment may therefore be used to replace two unidirectional power converters. As will be described, an embodiment of the present invention device combines two conventional switching (e.g., power transistors) components into a single bidirectional switching component.

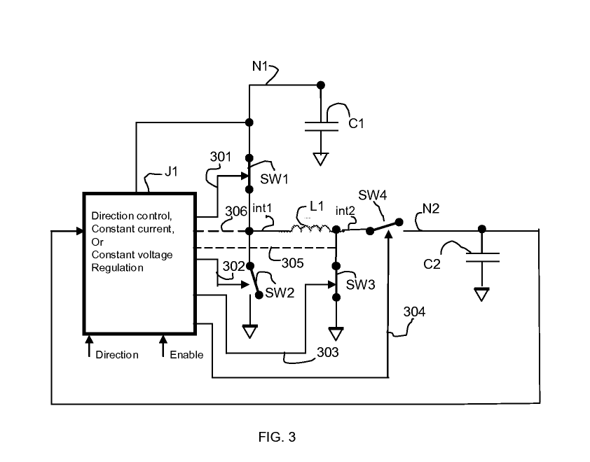

FIG. 3 is a circuit diagram illustrating an exemplary bi-directional power converter that is able to step-up and step-down in both directions, in accordance with an embodiment of the present invention. The present embodiment can provide power conversion from a power node N1 to a power node N2, from power node N2 to power node N1, or can be in an off mode. The voltage on a “direction” pin determines whether power conversion is from power node N1 to power node N2 or from power node N2 to power node N1. The voltage on an “enable” pin determines whether the power converter is enabled or in the off mode. Components SW1, SW2, SW3, and SW4 may be switches or may be a combination of switching elements and current sensing elements to provide a switching function or both a switching function and a current sensing function. In the switching function, the power converter enables a transfer current to flow in an ON mode and prevents current flow in the off mode. The current sensing function enables the power converter to sense the amount of current flowing through the switching element of the component.

The combination of components SW1 through SW4 and an inductor L1, also referred to as a power train, can provide bi-directional power conversion. In one embodiment, if the power conversion is from power node N1 to power node N2, making power node N1 the input node and power node N2 the output node, the switching transistors of component SW1 and component SW3 operate in phase and are in opposite phase to component SW2 and component SW4. That is component SW1 and component SW3 turn on together, and, when component SW1 and SW3 are in the ON mode, component SW2 and component SW4 are in the off mode. When component SW1 and component SW3 are turned ON, the inductor current is ramped up as a terminal int1 of inductor L1 is connected to power node N1 through the switch element of component SW1, which is in the ON mode, and a terminal int2 of inductor L1 is connected to ground through the switch element of component SW3. When component SW2 and component SW4 turn on, this inductor current is delivered to the output node, power node N2. The ON time of component SW1 and component SW3 determine how much energy is transferred to the output node, power node N2. If the output voltage, as sensed by a controller J1 by means of sensing the voltage on power node N2, is lower than the required voltage, component SW1 and component SW3 are turned ON, by means of control signals on 301 and 303, for a longer time by controller J1, thus ramping the inductor current for a longer time. Thus inductor L1 has more current to transfer to the output node, power node N2, when switch elements of component SW2 and component SW4 are turned ON by means of control signals 302 and 304. This increases the output voltage at power node N2. Similarly, when the output voltage is higher than the required voltage, the ON time of the switch elements of component SW1 and component SW2 is decreased by controller J1 until the output voltage reaches regulation. In the steady state, when the output voltage is in regulation, controller J1 maintains the steady state ON time, or duty cycle, of component SW1 and component SW3.

Similarly, in an alternate embodiment, the power conversion can be from power node N2 to power node N1 where power node N2 is the input node and power node N1 is the output node and the roles of components SW1 and SW3 are reversed with the roles of components SW2, and SW4.

Thus a function of controller J1 is to determine the direction of power conversion by sensing the direction of the input and regulating the voltage configured as the output at a required value by sensing the voltage at the power node configured as output and controlling the ON time of the switching elements.

In the present embodiment, capacitor components C1 and C2 reduce the voltage ripple on power nodes N1 and N2 by supplying the current. Those skilled in the relevant art will recognize in light of the present teachings that the output can be regulated by several means such as, but not limited to, constant frequency (or PWM) mode, constant ON time, constant OFF time, pulse frequency modulation and pulse skipping mode. Embodiments of the present invention can be applied to any control method for regulating the output voltage. Furthermore, the control and regulation of the output voltage may be controlled through various means such as, but not limited to, voltage mode control, peak current mode control, hysteretic mode control, and average mode control. Therefore, the scope of embodiments of the present invention is not limited to the mode of control but by the connectivity power train components SW1 through SW4 and inductor L1.

Furthermore, the current available from the input power node may be limited in some embodiments. For example, without limitation, if the input power is from a USB host, the maximum current available to be drawn from the USB port is limited. Similarly if the input power source is a wall adapter to charge the battery, the available current is limited, and it is desirable to limit the current drawn by the system to be less than the maximum current that could be provided by the input power source. It is another optional function of controller J1 to implement this feature. For example, without limitation, if power node N1, as shown by way of example in FIG. 3, is configured as an input node, the current drawn from the input can be sensed by the current flowing through either of the switch elements of component SW1 or component SW3 when they are in the ON mode by sensing the voltage drop across the SW1 by sensing the voltages on nodes N1 and int1 through signal on 306 or by sensing the voltage drop across SW3 by sensing voltages on node int2 through signal on 305 and ground. Controller J1 turns off the switching elements immediately when the sense current exceeds the pre-set current limit value. Thus, controller J1 controls the amount of ON time for the switching elements of components SW1 and SW3 to limit the current drawn from the input node rather than the ON time desired to regulate the output voltage. Thus, in one embodiment, if the current drawn through the input exceeds the input current limit, the ON time of components SW1 and SW3 terminates and takes precedence over regulating the output voltage. It is known for those acquainted with the relevant art that the input and output currents of a power converter are related by the duty cycle of the power converter. Thus, in another embodiment, the input current can also be calculated by sensing the output current or the current flowing through either of the switch elements SW2 or SW4 when they are in the ON state.

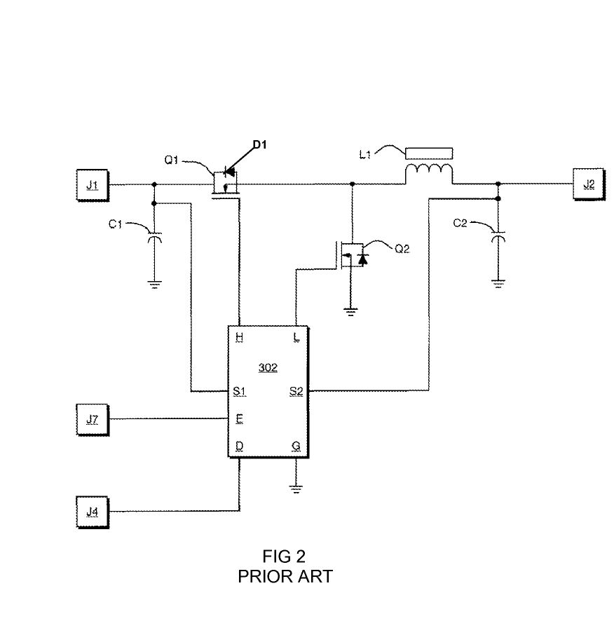

The operation is similar in the reverse direction where the roles of components SW1 and SW3 and components SW2 and SW4 are reversed. When in off mode, components SW1 and SW4 are open, unlike in the device shown by way of example in prior art in FIG. 2, and provide complete isolation and prevent reverse leakage between power node N1 and power node N2

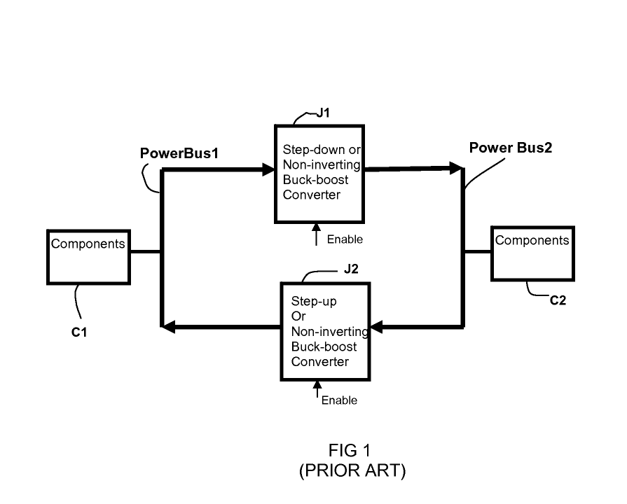

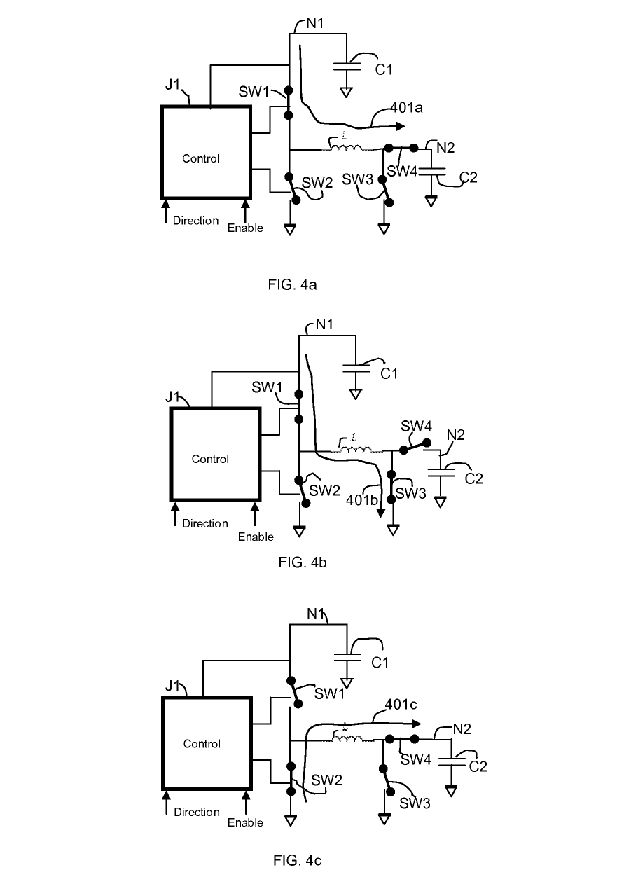

FIGS. 4a, 4b, 4c are circuit diagrams illustrating the operation of switching elements in a single period of power conversion from a power node N1 to a power node N2 in an exemplary bi-directional power converter in buck-boost mode, according an embodiment of the present invention. FIG. 4a illustrates phase 1, FIG. 4b illustrates phase 2, and FIG. 4c illustrates phase 3. In the present embodiment, phase 1, phase 2, and phase 3 are non-overlapping in time. Unlike the two-phase operation described in accordance with the prior art device shown by way of example in FIG. 1, where components SW1 and SW3 operate in phase and components SW2 and SW4 operate in phase, in the present embodiment the switch operation has three phases. In phase 1, an inductor L is charged by closing switches SW1 and SW4 and delivers power to an output node N2. In phase 2, inductor L continues to charge through the switching elements of components SW1 and SW3, and an output capacitor C2 delivers power to the load. In phase 3, inductor L delivers current to the output node, power node N2, by closing the switching elements of components SW2 and SW4. Thus, the scope of the present embodiment is not limited by the sequence of switching element turn ONs and turn offs, but only by the connectivity of the power train components, SW1 through SW4 and inductor L, a capacitor C1 and output capacitor C2.

The embodiments shown by way of example in FIG. 3 and FIG. 4 can convert both step-up and step-down in each direction. Additional implementations are possible. For example, without limitation, instead of switching all of the switching elements of components SW1 through SW4 all of the time, the switching losses can be minimized by having some switching elements on while having some switching elements off, based on input to output conversion.

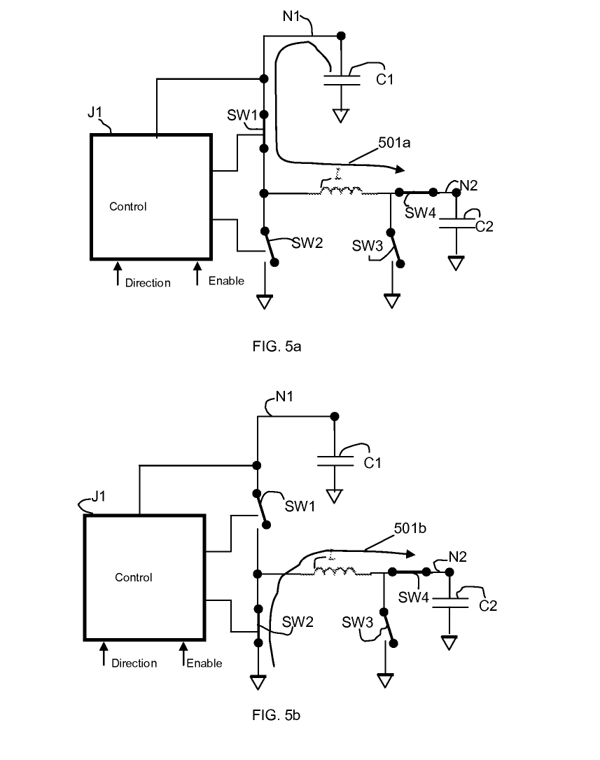

It will be apparent to those skilled in the relevant art in light of the present teachings that if the power conversion is step-down, meaning the input voltage is higher than the output voltage, not all of the switches must be turned on, as shown by way of example in FIG. 5. FIG. 5a and 5b are circuit diagrams illustrating the operation of switching elements in an exemplary bi-directional power converter in a single period of power conversion from a power node N1 to a power node N2 when only step-down operation is required from power node N1 to power node N2, in accordance with an embodiment of the present invention. FIG. 5a illustrates the current flow in phase 1, and FIG. 5b illustrates the current flow in phase 2. The present embodiment is in step-down mode, that is, when the voltage on power node N1 is higher than the required voltage on power node N2. For power conversion from power node N1 to power node N2 switching elements in components SW3 and SW4 need not be switched, the switching element in component SW3 can remain open, the switching element in component SW4 can be closed, and only the switching elements of components SW1 and SW2 need to be switched. In the present embodiment, the switching element in component SW4 is always in the ON mode and the switching element in component SW3 is always in the OFF mode. Switching elements of components SW1 and SW2 operate in opposite phase. When the switching element of component SW1 is ON, an inductor L is charged and delivers power to the output, and when the switching element of component SW2 is ON, inductor L discharges and an output capacitor C2 delivers power to the load on power node N2.

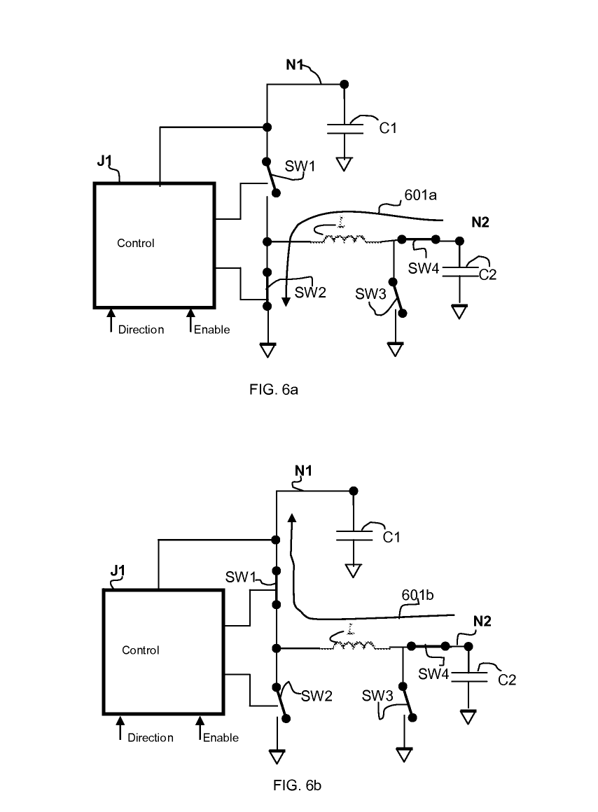

FIG. 6a and 6b are circuit diagrams illustrating the operation of switching elements in an exemplary bi-directional power converter in a single period of power conversion from a power node N2 to a power node N1 when only step-up operation is required from power node N2 to power node N1, in accordance with an embodiment of the present invention. FIG. 6a illustrates the current flow in phase 1, and FIG. 6b illustrates the current flow in phase 2. Similarly to the example shown in FIGS. 5a and 5b, if the conversion is only step-up for power conversion from power node N2 to power node N1, the switching element of a component SW3 can be left open and the switching element of a component SW4 can be closed. In step-up mode the input voltage at power node N2 is lower than the required voltage on power node N1. Again, the switching element of component SW3 is always in the ON position and the switching element of component SW4 is always in the off mode. In phase 1 an inductor L is charged by closing the switching element of component SW2. In phase 2, the switching element of component SW1 is in the ON mode and inductor L delivers power to output at power node N1.

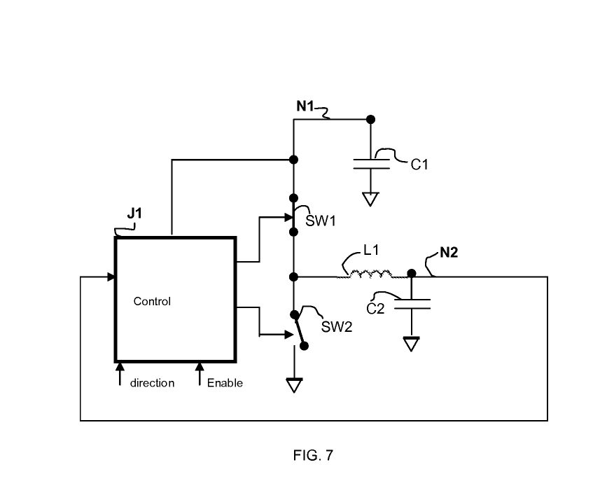

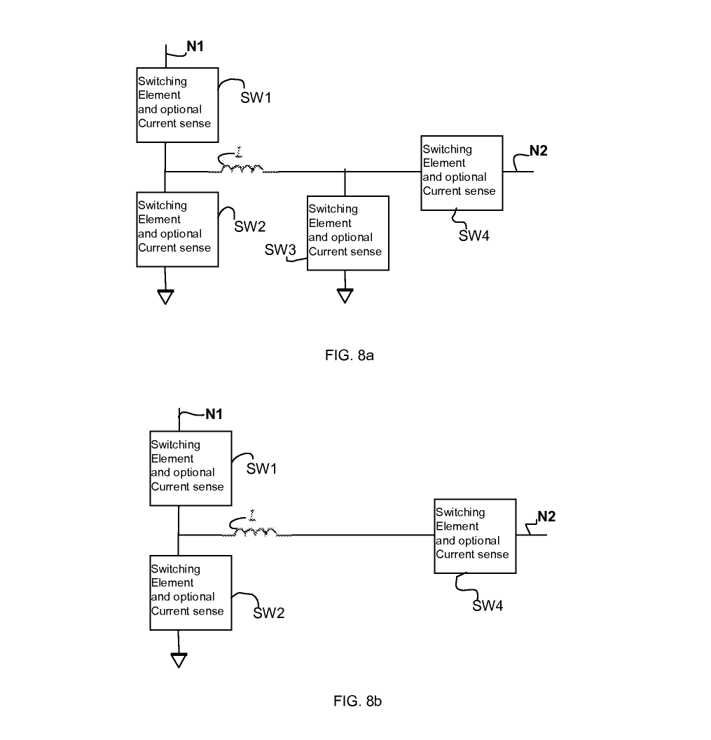

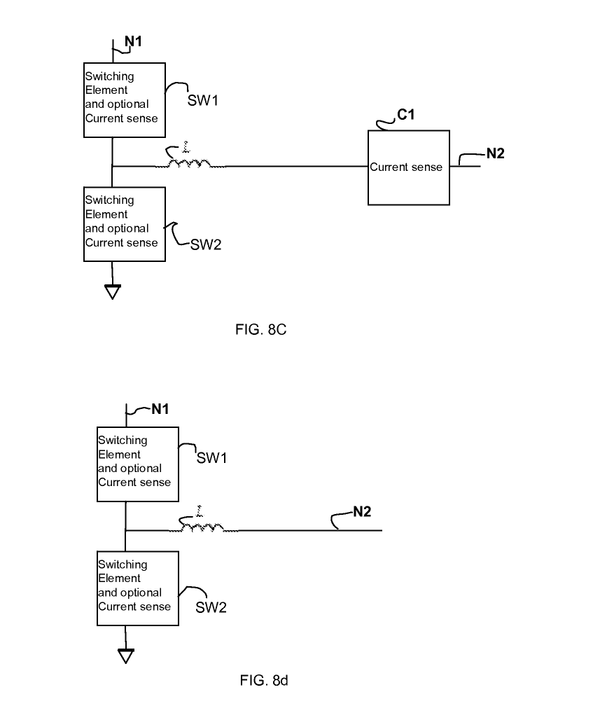

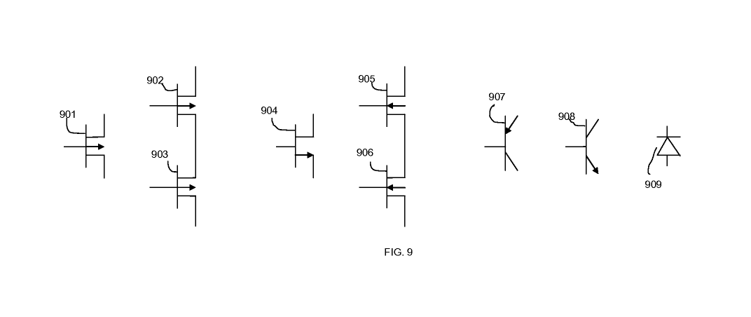

If the power conversion is always step-up in one direction and step-down in the other direction, the switching elements of component SW3 and/or component SW4 can be eliminated as shown by way of example in FIGS. 7 through FIG. 8d. FIG. 7 is a circuit diagram of an exemplary bi-directional power converter where only step-down power conversion from a power node N1 to a power node N2 and step-up power conversion from power node N2 to power node N1 is required, in accordance with an embodiment of the present invention. In the present embodiment, components SW3 and SW4 are not required, as shown by way of example in FIGS. 1 through 6b. In the present embodiment, components SW1 and SW2 are switches in series with current sensing resistors and, in some embodiments, may enable the power converter to perform a lossless current sensing function. In the present embodiment, components SW1 and SW2 operate out-of-phase and the step-up and step-down operation is similar to that shown by way of example in FIGS. 5a through 6b if component SW4 is replaced with a short and component SW3 is open or removed from the circuit.

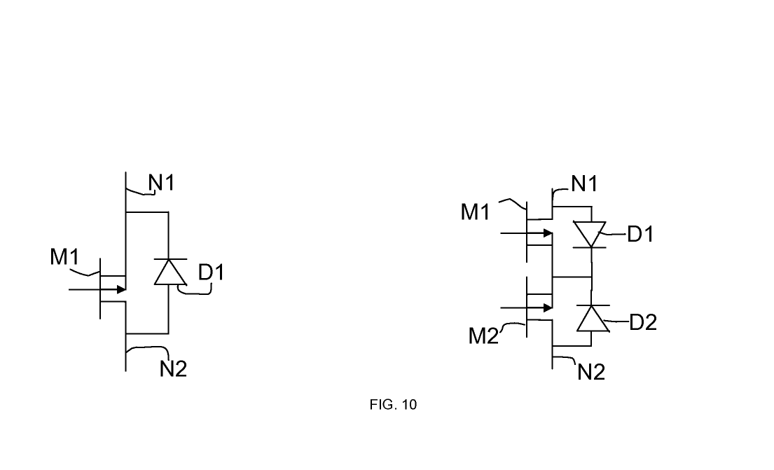

The difference between the present embodiment to that of the prior art shown by way of example in FIG. 2 is that unlike transistors Q1 and Q2 in FIG. 2 components SW1 and SW2 may not be simply single transistors. Rather, components SW1 and SW2 may be a series connection of two transistors, as shown by way of example in FIGS. 9 and 10. The series connection of the transistors is done such that their parasitic diodes are connected back-to-back to avoid reverse leakage current if no voltage conversion is required. Additionally, components SW1 and SW2 may also comprise current sensing components, to sense the input currents. In the present embodiment, limiting input current takes precedence over regulating output voltage if the output draws more current than can be provided by the input. In addition, current mode converters use the current sense feedback, in addition to the output voltage sense for output voltage regulation. Thus the present embodiment overcomes the drawbacks of the prior art.

FIG. 9 illustrates some implementation examples for providing the switching function. The switching function may be implemented by any series or parallel combination of these elements. For those skilled in the relevant art, it is known that the current sensing function may be implemented in several ways. Some non-limiting examples of sensing the current are as follows. One implementation is having a resistor in series with the switching transistor and measuring the voltage across the resistor. In this implementation, the voltage across the resistor terminals is also the input to a component J1. The resistor may be an additional resistor or may be the metal routing resistor of the switching transistor. Current sensing function can also be implemented by measuring the voltage across the switching transistor when it is ON. Additionally, the current sensing function can be accomplished through a sense transistor that mirrors the current through the switching transistor.

FIGS. 8a, 8b, 8c, and 8d illustrate various exemplary power train elements of a bi-directional power converter, in accordance with embodiments of the present invention. FIG. 8a illustrates a four-switch power train. FIG. 8billustrates a three-switch power train. FIG. 8c, illustrates a two-switch power train with a current sensing element, and FIG. 8d illustrates a two-switch power train. FIG. 8a illustrates a four-switch embodiment. This embodiment can perform both step-up and step-down power conversion in both directions. Also, in the present embodiment, current flowing through the power node configured as the input can be measured by sensing the current through any of components SW1 through SW4. If the power conversion is from a power node N1 to a power node N2, the current drawn from the input, power node N1, can be sensed by sensing the current flowing through the switching element of component SW1 or component SW3 when these components are in the ON mode. Similarly, when power conversion is from power node N2 to power node N1, the input current drawn from the input, power node N2, can be sensed by sensing the current flowing through the switching element of component SW2 or component SW4 when these components are in the ON mode.

If power conversion is step-up in one direction and step-down-in the other direction, two or three switch embodiments as illustrated by way of example in FIGS. 8b, 8c and 8d may be used. In these embodiments the power conversion is step-down from a power node N1 to a power node N2 and step-up from power node N2 to power node N1. The exemplary power converter shown in FIG. 8bcomprises three switches. In this embodiment current flowing through the power node configured as the input can be measured by sensing the current flowing through any of components SW1, SW2 or SW4. The switching element of component SW4 is closed when the power converter is enabled and is open when the power converter is in the OFF mode. FIG. 8cillustrates a two-switch power converter. In this embodiment current flowing through the power node configured as the input can be measured by sensing the current flowing through either component SW1 or SW2 or by sensing the current flowing through a current sensing element C1 connected in series with an inductor L. The exemplary power converter illustrated in FIG. 8d is a two-switch embodiment. In this embodiment, current flowing through the power node configured as the input can be measured by sensing the current flowing through component SW1 or component SW2. The difference between the embodiments shown by way of example in FIGS. 8b and 8d is that the embodiment shown in FIG. 8bcomprises an additional component with a switching element, component SW4. Functions of the switching element in component SW4 are to provide a current sense function and/or to substantially prevent current flowing from power node N2 to power node N1 through a parasitic diode of a switch transistor of component SW1 as explained by way of example in accordance with FIG. 10.

The operation of the power converters illustrated by way of example in FIGS. 8a through 8d is similar to that of the embodiments illustrated by way of example in FIGS. 5 and 6 where component SW3 is removed and component SW4 is short. The difference between the embodiments shown in FIGS. 8a through 8bto the prior art converter shown by way of example in FIG. 2 is that, unlike transistors Q1 and Q2 in the prior art converter, components SW1 and SW2 in the present embodiments may not be simply single transistors. Rather, components SW1 and SW2 may be a series connection of two transistors as shown, by way of example in FIG. 9. A series connection of the transistors is done such that the parasitic diodes of the transistors are connected back-to-back to avoid reverse leakage of current if no voltage conversion is required. Additionally, switching elements in the present embodiments may be single transistors if component SW4 is included in the power converter, as shown by way of example in FIGS. 8a and 8b. In this case component SW4 is closed when the power converter is enabled and is open to prevent reverse leakage if the power converter is in the off mode. Additionally, components SW1 and SW2 may also comprise current sensing components, to sense the input currents. In the present embodiments, limiting the input current takes precedence over regulating output voltage if output draws more current than that could be provided by the input. In addition, current mode converters may use the current sense feedback in addition to the output voltage sense feedback for output regulation

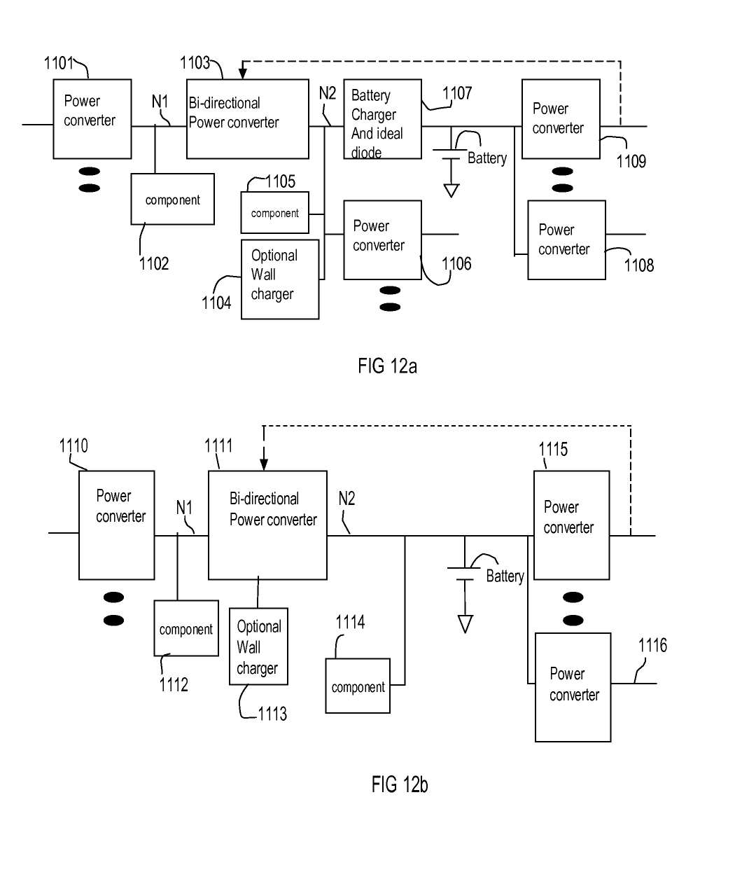

FIGS. 12a and 12b illustrate various embodiments of the bi-directional converter connectivity in a system. Components can be directly connected to the inputs and outputs of the converter. Other power converters may be connected to the input and the outputs of the bi-directional converter. Additionally, battery charging can be supported by the bi-directional converter directly or through a battery charger connected to the output of the bi-directional converter. In addition, the system may have more than one bi-directional converter. For example, without limitation, two bi-directional converters can be connected in parallel for multi-phase operation. For those skilled in the relevant art, it will be apparent in light of the present teachings that several additional configurations are possible for bi-directional connectivity.

FIGS. 9 and 10 show some implementation examples to provide the switching function for the switching elements of components SW1 through SW4 illustrated by way of example in FIGS. 3 through 8d. For those acquainted with the relevant art in light of the present teachings, it will be apparent that the switch can be implemented by various means such as, but not limited to, a NMOS transistor, a PMOS transistor, a NPN transistor, a PNP transistor or a diode. FIGS. 9a, and 9b illustrate various exemplary implementations of switch elements of an exemplary power converter, in accordance with embodiments of the present invention. FIG. 10 illustrates exemplary switching elements, including a schematic model showing the parasitic conduction diode in a single and series connected PMOS/NMOS MOSFET transistors. Each implementation has advantages and disadvantages. Bipolar transistors provide higher current capability for a given silicon area yet require a base current. Conversely, NMOS and PMOS transistors do not require base currents and can be fabricated using a cheaper CMOS process. A schottky diode may also be used. The advantage of using a schottky diode is that no drive signal is required to turn-on the device as the current flowing through the inductor pulls the voltage on the diode to turn it on. However, typically the voltage drop across a schottky diode is around 0.3V to 0.4V thus making the power converter less efficient.

The switching function may also be implemented by any series or parallel combination of these elements. FIG. 10 illustrates an exemplary parasitic diode of a switching transistor in a bi-directional power converter, in accordance with an embodiment of the present invention. Switch transistors typically have parasitic diodes between the bulk and drain as shown by diodes D1 and D2. If a single transistor is used, it may be possible to forward bias diode D1 as a parasitic diode allowing the current to flow between the switch terminals even when the switch is in the off mode. For example, without limitation, when only a switch transistor M1 is used and the voltage on a power node N2 is higher than the voltage on a power node N1, parasitic body diode D1 is forward biased and starts conducting current even when switch transistor M1 is off. A reason for connecting two transistors in series is to prevent this current flowing through the parasitic diode. The transistors are connected such that if the body diode of one transistor is forward biased, the body diode of the other transistor is reverse biased thus preventing the current flow through the reverse biased diode. For example, without limitation, as shown by way of example in FIG. 10, if two transistors M1 and M2 are connected in series and power node N2 is higher in voltage than power node N1, parasitic diode D2 is forward biased. However, diode D1 is reverse biased since the cathode of diode D1 is at higher potential than the anode on power node N1, thus preventing the current flow through parasitic diode D2.

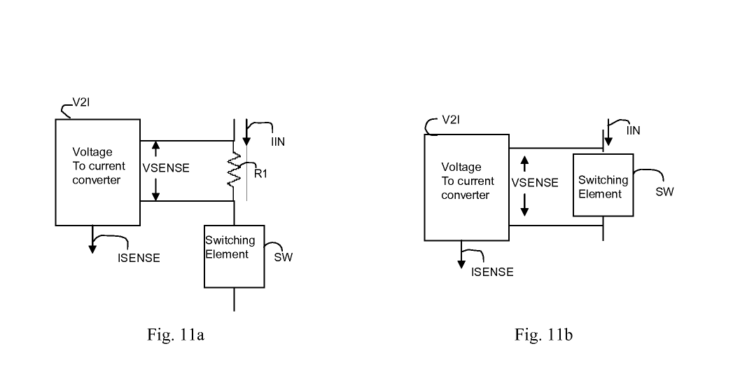

FIGS. 11a and 11b illustrate exemplary implementations for a current sensing function in a bi-directional power converter, in accordance with embodiments of the present invention. FIG. 11a illustrates a current sensing function employing a resistor R1, and FIG. 11b illustrates a current sensing function that measures the voltage across a switching transistor SW. For those skilled in the relevant art, it is known that a current sensing function to sense the current flowing through a switch may be implemented in several ways. For example, without limitation, current sense may be implemented by having resistor R1 in series with a switching transistor SW and measuring a voltage VSENSE across resistor R1 as shown by way of example in FIG. 11a. In this implementation, the voltage across the terminals of resistor R1 is also input to component J1, shown by way of example in FIGS. 3 through 7. A component V2I converts this VSENSE voltage into a current ISENSE where current ISENSE is proportional to a current IIN flowing through the switch. Resistor R1 may be an additional resistor or may simply be the metal routing resistor of switching transistor SW. In an alternate embodiment, shown by way of example in FIG. 11b, a current sensing function can also be implemented by measuring a voltage VSENSE across switching transistor SW when switching transistor SW is in the ON mode. As in the previous example, a component V2I converts this VSENSE voltage into a current ISENSE where current ISENSE is proportional to a current IIN flowing through switching transistor SW. Additionally, in another embodiment, a current sensing function can be implemented through a sense transistor which mirrors the current through the switching transistor.

FIGS. 12a and 12b are block diagrams illustrating exemplary implementations of using a bidirectional converter in an electronic system, in accordance with embodiments of the present invention. A bi-directional power converter according to embodiments of the present invention may also be used to provide battery-charging function. Shown in the FIGS. 12a and 12b is a battery in series with an optional current sense resistor or transistor is connected to the output node of the bi-directional power converter directly or through a battery charger. In the embodiment shown by way of example in FIG. 12a, the step-down voltage from the bi-directional converter generates an intermediate voltage rail that can be used for battery charging. In the embodiment shown by way of example in FIG. 12b, the bi-directional power converter alone can be used for battery charging. FIG. 12a illustrates a system wherein the bi-directional converter converts the voltage on Node N1 to a voltage suitable to power the components connected on Node N2 including a battery charger. In this embodiment, the function of the bi-directional power converter is to provide power conversion between nodes N1 and N2. When a power source is available on Power node N1, the bi-directional power converter provides a voltage on node N2 and when no power source is present on node N1, battery provides power to node N2 through active diode and bi-directional converter converts this voltage on node N2 to power components connected on node N1. FIG. 12b illustrates a system wherein a battery is directly connected to the output of the bi-directional converter at node N2 and the bi-directional converter provides the battery charging function

The process of battery charging depends on the chemistry of the battery and the present invention is not limited to particular battery chemistry. For example, most batteries require a trickle charge current if the battery is deeply depleted. Once the battery reaches a predetermined voltage, it is charged in constant current mode with the charge current higher than that in the trickle charge. If the battery is to be charged in constant current mode, the power conversion is from first power node N1 to second power node N2 and the feedback loop of the bi-directional power converter maintains the sensed current flowing into the second power node at a constant level if this current doesn't exceed the current than can be provided by the power source connected on power node N1, if it exceeds, then the power converter maintains the current at the maximum current level that can be provide by the power source connected on N1. If the battery is to be charged in constant voltage mode, the power conversion is from the first power node to second power node and the feedback loop maintains the battery voltage at a constant voltage level. If battery charging is disabled, the power converter is in the off mode. If the step-up mode is selected, the power conversion is from the battery power at second power node to first power node and the feedback loop maintains the first voltage at a constant level.

FIGS. 12a and 12b also illustrate examples of the connectivity of an exemplary bi-directional converter in a system. For example, without limitation, components can be directly connected to the inputs and outputs of the converter. Other power converters may be connected to the input and the outputs of the bi-directional converter. Additionally, battery charging can be supported by the bidirectional converter directly or through a battery charger connected to the output of the bi-directional converter. In addition, system could have more than one bi-directional converter. In addition, two bi-directional converters can be connected in parallel for multi-phase operation. Multi-phase operation is typically used when higher current capability is required from the power converter. For those skilled in the relevant art in light of the present teachings, it will be apparent that several additional configurations are possible. Those skilled in the art will readily recognize, in accordance with the teachings of the present invention, that any of the foregoing system components and modules may be suitably replaced, reordered, removed and additional system modules may be inserted depending upon the needs of the particular application, and that the systems of the foregoing embodiments may be implemented using any of a wide variety of suitable connections arid system modules, and is not limited to any particular hardware, software, middleware, firmware, microcode and the like.

Having fully described at least one embodiment of the present invention, other equivalent or alternative means for implementing a bi-directional DC power converter according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A bidirectional power converter comprising:
a circuit comprising a first power node, a second power node, a first internal node and a second internal node;
a first energy storage component coupled between said first power node and ground;
a second energy storage component coupled between said second power node and ground;
a first switch coupled between said first power node and said first internal node, wherein said first switch allows current flow between said first power node and said first internal node when said first switch is in a closed position;
a second switch coupled between said first internal node and ground, wherein said second switch allows current flow between said first internal node and ground when said second switch is in a closed position;
a third switch coupled between said second internal node and ground, wherein said third switch allows current flow between said second internal node and ground when said third is in a closed position;
a fourth switch coupled between said second power node and second internal node, wherein said fourth switch allows current flow between said second power node and said second internal node when said fourth switch is in a closed position;
an inductive component coupled between the first internal node and second internal node; and
a controller comprising a first voltage-sensing input coupled to said first power node, a second voltage-sensing input coupled to said second power node and switch control outputs for controlling said first, second, third and fourth switches in a manner such that power conversion occurs from said first power node to said second power node, from said second power node to said first power node, or power conversion is disabled and said first and second power nodes are isolated from each other.

2. The power converter as recited in claim 1, in which said controller further comprises means for determining direction of power conversion of the converter.

3. The power converter as recited in claim 2, in which said controller further comprises a pulse generator for controlling said first, second, third and fourth switches, said pulse generator being controlled in part by a signal from said first or second voltage-sensing input.

4. The power converter as recited in claim 3, further comprising current sensing means capable of producing a feedback signal for said controller where said pulse generator is controlled in part by said feedback signal.

5. The power converter as recited in claim 4, in which one or more of said first, second, third and fourth switches comprise said current sensing means.

6. The power converter as recited in claim 4, in which said inductive component comprises said current sensing means.

7. The power converter as recited in claim 4, where said feedback signal indicates a current of said input and said pulse generator is controlled to limit said current.

8. A bi-directional power converter comprising:
a circuit comprising a first power node, a second power node, a first internal node and a second internal node;
a first energy storage component coupled between said first power node and ground;
a second energy storage component coupled between said second power node and ground;
a first switch coupled between said first power node and said first internal node, wherein said first switch allows current flow between said first power node and said first internal node when said first switch is in a closed position;
a second switch coupled between said first internal node and ground, wherein said second switch allows current flow between said first internal node and ground when said second switch is in a closed position;
a third switch coupled between said second power node and second internal node, wherein said third switch allows current flow between said second power node and said second internal node when said third switch is in a closed position;
an inductive component coupled between the first internal node and second internal node; and
a controller comprising a first voltage-sensing input coupled to said first power node, a second voltage-sensing input coupled to said second power node and switch control outputs for controlling said first, second and third switches in a manner such that power conversion occurs from said first power node to said second power node, from said second power node to said first power node, or power conversion is disabled and said first and second power nodes are isolated from each other.

9. The power converter as recited in claim 8, in which said controller further comprises means for determining direction of power conversion of the converter.

10. The power converter as recited in claim 9, in which said controller further comprises a pulse generator for controlling said first, second and third switches, said pulse generator being controlled in part by a signal from said first or second voltage-sensing input.

11. The power converter as recited in claim 10, further comprising current sensing means capable of producing a feedback signal for said controller where said pulse generator is controlled in part by said feedback signal.

12. The power converter as recited in claim 11, in which one or more of said first, second and third switches comprise said current sensing means.

13. The power converter as recited in claim 11, in which said inductive component comprises said current sensing means.

14. The power converter as recited in claim 11, where said feedback signal indicates a current of said input and said pulse generator is controlled to limit said current.

15. A bidirectional power converter comprising:
a circuit comprising a first power node, a second power node and an internal;
a first energy storage component coupled between said first power node and ground;
a second energy storage component coupled between said second power node and ground;
a first switch coupled between said first power node and said internal node, wherein said first switch allows current flow between said first power node and said internal node when said first switch is in a closed position and leakage current is substantially prevented in an open position;
a second switch coupled between said internal node and ground, wherein said second switch allows current flow between said internal node and ground when said second switch is in a closed position and leakage current is substantially prevented in an open position;
an inductive component coupled between the first internal node and second power node; and
a controller comprising a first voltage-sensing input coupled to said first power node, a second voltage-sensing input coupled to said second power node and switch control outputs for controlling said first and second switches in a manner such that power conversion occurs from said first power node to said second power node, from said second power node to said first power node, or power conversion is disabled and said first and second power nodes are isolated from each other.

16. The power converter as recited in claim 15, in which said controller further comprises means for determining direction of power conversion of the converter.

17. The power converter as recited in claim 16, in which said controller further comprises a pulse generator for controlling said first and second switches, said pulse generator being controlled in part by a signal from said first or second voltage-sensing input.

18. The power converter as recited in claim 17, further comprising current sensing means capable of producing a feedback signal for said controller where said pulse generator is controlled in part by said feedback signal.

19. The power converter as recited in claim 18, in which said first or second switch comprises said current sensing means.

20. The power converter as recited in claim 18, in which said inductive component comprises said current sensing means.

21. The power converter as recited in claim 18, where said feedback signal indicates a current of said input and said pulse generator is controlled to limit said current.

22. A bi-directional power converter comprising:
a circuit comprising a first power node, a second power node, a first internal node and a second internal node;
first energy storage means for storing energy on said first power node;
second energy storage means for storing energy on said second power node;
first switch means for allowing current flow between said first power node and said first internal node;
second switch means for allowing current flow between said first internal node and ground;
third switch means for allowing current flow between said second internal node and ground;
fourth switch means for allowing current flow between said second power node and said second internal node;
inductive means for transferring current between the first internal node and second internal node; and
controller means for controlling said first, second, third and fourth switch means in a manner such that power conversion occurs from said first power node to said second power node, from said second power node to said first power node, or power conversion is disabled and said first and second power nodes are isolated from each other.

23. The power converter as recited in claim 22, further comprising voltage sense means for sensing voltage at said power nodes.

24. The power converter as recited in claim 23, further comprising current sense means for sensing current in said power nodes.

25. A circuit for use in a bidirectional power converter, the circuit comprising:
a power train comprising a first power node, a second power node, a first internal node and a second internal node;
first energy storage means for storing energy on said first power node;
second energy storage means for storing energy on said second power node;
first switch means for allowing current flow between said first power node and said first internal node;
second switch means for allowing current flow between said first internal node and ground;
third switch means for allowing current flow between said second internal node and ground;
fourth switch means for allowing current flow between said second power node and said second internal node; and
inductive means for transferring current between the first internal node and second internal node where when said switches are controlled power conversion occurs between said power nodes.

26. The circuit as recited in claim 25, further comprising voltage sense means for sensing voltage at said power nodes.

27. The circuit as recited in claim 26, further comprising current sense means for sensing current in said power nodes.
